(19) United States
(12) Patent Application Publication
(10) Pub. No.: US 2017/0081797 A1
(43) Pub. Date: Mar. 23, 2017

(54) Washing Process Including Proteinaceous Soils Removal Step

(71) Applicant: Whirlpool S.A., Sao Paulo (BR)

(72) Inventors: Aliander Filgueiras da SILVA, Rio Claro (BR); Caio Cesar Rodrigues FERRARI, Rio Claro (BR)

(73) Assignee: Whirlpool S.A.

(21) Appl. No.: 15/272,639

(22) Filed: Sep. 22, 2016

(30) Foreign Application Priority Data
Sep. 22, 2015 (BR) 102015024367 7

(51) Int. Cl. D06F 39/02; C11D 3/39; C11D 3/386; C11D 11/00

(52) U.S. Cl. CPC D06F 39/02; C11D 11/0017; C11D 3/3942; C11D 3/3917; C11D 3/386; C12Y 304/21062

(57) ABSTRACT

The present invention related to the technological field of washing process of textile articles in general.
The washing process here revealed can, by the orderly execution of its steps, separate physically part of the “standard detergent” particles defined on ordinance 185 from Inmetro, of Sep. 15, 2015, making the “detergent type A” to reach first the proteinaceous soils, and together, with perborate having bigger and more dense particles it is laid up on the bottom of the washing basket, needing to be taken inside the basket by the water flow generated by mechanic stirring of washing machine. Consequently, the process of perborate being dissolved and interacting with “detergent type A” enzymes.

### FIELD OF THE INVENTION

The present invention relates to a washing process, amenable to implementation in a conventional washing machine includes at least one step of increasing efficiency in the removal of proteinaceous soils such as blood stains.

In general, the soil proteinaceous removal step has the overall foundation enables the optimization of the dissolution and the action time of the three components (base powder blown enzyme and foam inhibitor, sodium perborate tetrahydrate and bleach activator tetra acetyl ethylene diamine) that makes up the “standard detergent” defined in ordinance 185 Inmetro, of Sep. 15, 2015.

### BACKGROUND OF THE INVENTION

As is known to those skilled in the art, washing textile processes may be performed automatically or semi-automatically in washing machines, either in the vertical axis washers or horizontal axis washers.

In short, the textile washing processes carried out in washing machines comprise multiple steps, each with its own purpose.

In any case, the removal of soil usually occurs in the agitation stage, where textiles—previously submerged in favorable aqueous (water and alkaline compound)—are subjected to friction with each other and the walls of the basket wash.

In general, and as is known to the skilled technicians in the subject, the washing liquid acts with conductive agent of free ions contained in the soap molecules, and these ions act in capturing particles of soil. The nonpolar molecule chain involves the trapped soils in the tissues, or floating in solution, in a process known as emulsification. The friction between the textile articles generated during the agitation stage works by removing larger soil particles strictly dependent of mechanical action for the release of tissue fibers.

Accordingly, the washing liquid is usually quoted composed of a dilution of at least one cleaning ingredient, also known as detergent.

A “standard detergent” as defined in the ordinance 185 Inmetro, of Sep. 15, 2005, is usually composed of three different components: base powder blown enzyme and foam inhibitor (also known as “detergent type A”, sodium perborate tetrahydrate and bleach activator tetra acetyl ethylenediamine. These three components are used in different proportions being 77% of base powder blown enzyme and foam inhibitor, 20% tetrahydrate sodium perborate and 3% bleach activator tetra acetyl ethylenediamine. This “detergent type A” which includes the “standard detergent” has in its composition Savinase 8.0 enzyme, which is responsible for the breakdown of proteins into small pieces by hydrolyzing the peptide bonds that link amino acids of a protein to others.

It happens that when the enzyme is exposed to oxidizing agents, such as the tetrahydrate sodium perborate, their activities are drastically reduced, in consequence, the efficiency in the removal of proteinaceous soils is adversely affected.

This feature can be clearly observed in efficiency tests, such as the “pattern test” also defined in ordinance 185 Inmetro, of Sep. 15, 2015. For the realization of this “pattern test”, the three components included in the “standard detergent” must be mixed and supplied on site recommended by the product manufacturer's manual (usually in the washer dispenser). From the moment in which the powder comes into contact with the water begins to occur the dissolution process and after a certain time, the dissolved perborate comes into contact with the enzymes “detergent type A”, which makes it difficult the process of removing proteinaceous soil, resulting in textile articles with proteinaceous soil, the incidence of dark spots amid light spots.

Moreover, it is also known to the skilled technicians in the art that different compositions of aqueous solutions (or simply washing water) act on certain types of soils and, depending on this, it is common to wash textiles further includes a manual sorting step, this step which aims to group together said textile articles according to the type of soiling thereof.

On the other hand, are known washing processes capable of cleaning textile articles of different soils. An example of this type of process is described in the document U.S. Pat. No. 6,277,153.

In general, these processes are based on the change in the characteristics (thermal, chemical, among others) of the washing water. So, at first, a washing water is used whose characteristics are suitable for cleaning certain types of soil and, in sequence, the same washing water is transformed in order to understand the characteristics to clean other soils.

While these processes are traditional, they can be seen that exhibit at least two aspects that can be improved, in which:

i) not always the amount of clothes with different soil compensates for the implementation of such specific washing processes; and

ii) The fundamental concept of these types of processes comprises adding chemicals, however, it is known that certain types of impurities tend to have a more complex removal if they are directly exposed to certain chemicals, such as the case of proteinaceous soils.

Based on this scenario that arises the invention in question.

Invention Goals

It is therefore the primary objective of the subject invention reveals a process of washing textile articles up to 40% efficiency as regards the removal of proteinaceous soil, when using the “standard detergent” as defined on ordinance 185 Inmetro, of Sep. 15, 2005.

Accordingly, it is one objective of the subject invention the cleaning process has the effect of sodium perborate tetrahydrate interaction with the enzymes “detergent type A” reduced at an early time of the wash cycle. Accordingly, it is an objective of the subject invention the cleaning process is able to highlight the textile articles protein molecules before occurs most of the interaction of these two components.

Finally, it is one objective of the subject invention that the removal of proteinaceous soil is facilitated through the greater part of the physical separation of the three components of the detergent through the aqueous solution in which the textile articles are submerged.

### SUMMARY OF THE INVENTION

The objectives mentioned above are fully achieved by the washing process including the removal of proteinaceous soil step, the type amenable to implementation in washing machines, which comprises at least the following sub-stages: introducing the articles textiles to be washed inside the washing basket; the washing basket filled to between 45% to 65% of the water column selected with aqueous solution level hydrogenionic potential (pH) in a range from 5 to 7; maintenance of textiles submersed in the aqueous solution the potential hydrogenionic level (pH) in a range between 5 to 7 for at least 90 seconds; introducing washing inputs in aqueous solution so as to alter the level of hydrogenionic potential (pH) for a range between 10 and 13; Mechanical drive of the washer agitation means so as to generate friction between clothes textile articles and at least a portion of the washing basket; and introducing again the aqueous solution the potential hydrogenionic level (pH) in a range between 5 to 7 up to 100% of the selected level of the water column.

Preferably, the aqueous solution comprises pure water and washing step inputs comprise a formulation primarily comprising base powder blown foam enzyme and inhibitor, sodium perborate tetrahydrate and bleach activator tetra acetyl ethylenediamine.

### DETAILED DESCRIPTION OF THE INVENTION

In general, the washing process including removal of proteinaceous soil stage, object of the present invention proposes a new form of dispensing the “detergent type A” to increase the removal efficiency of protein soils.

It is generally known that the washing and/or cleaning blood stains on textile fibers comprises something of great complexity.

This is because this type of cleaning and/or rinsing beyond the common sense, that is, it is known that the effectiveness of washing and/or cleaning general stains on textile fibers is related to washing input used, however this line of reasoning is not applicable to the proteinaceous soil, for example, blood stains.

It happens that when an impregnated textile fiber with proteinaceous soil is directly exposed to a washing input with high concentrations of oxidizing agents is that the skilled technicians in the art call the denaturation effect resulting in a better fixation of proteinaceous soils on the textile fiber. Consequently, instead of providing washing and/or cleaning, the washing inputs—in this particular situation—ends up acting contrary to the conventionally expected.

Accordingly, the washing process including the removal of proteinaceous soil step, according to the invention in question aims to control, in ascending order, the interaction of the sodium perborate with “detergent type A” enzymes of aqueous solution in which the textile articles are submerged. In addition, said process further comprises at least one time interval where the hydrogenionic potential (pH) of the aqueous solution is kept stable.

For this it is necessary to perform the basket rinsing filling through a valve in which not pass through the detergent dispenser, so most of the product is completed with water supply network without chemicals and in a second time at the end of the product filling process is performed detergent dispensing. With this action, because of the different densities of the components of the “standard detergent” as defined in the ordinance 185 Inmetro, of Sep. 15, 2005, you can physically separate part of the particles of the three components, causing the “detergent type A” first the proteinaceous soil, and along with it, as perborate has larger and more dense particles, it is placed in the washing basket bottom, needing to be taken into the basket through the water flow generated by the mechanical stirring of the washing machine. Consequently, the process of the perborate be dissolved and interact with the “detergent type A” enzymes. This dispensing detergent structure achieves more efficient levels of removal of proteinaceous soil.

In a broad sense, the washing process including the removal of proteinaceous soil step, according to the subject invention can be implemented in washing machines of conventional garments comprising filling control means of the washing basket, control means of dispensing washing inputs, time control means and rotational speed of the washing basket. Notably, it is widely known technical versed already the subject all the constructive technical details of this type of washing machine.

Thus, the subject invention comprises at least the following sub-steps:

(A) introducing the textile articles to be washed inside the washing basket;

(B) Fill the wash basket up to 55% of the water column selected with aqueous solution with potential hydrogenionic level (pH) in a range between 5 and 7. Preferably, this aqueous phase comprises water “pure” water of the supply network, however, chemical additives may be used (as known) to maintain or achieve the desired level of hydrogenionic potential (pH).

(C) maintaining the textiles submersed in the aqueous solution hydrogenionic potential level (pH) in a range between 5 to 7 for at least 90 seconds.

(D) introducing wash inputs in aqueous solution so as to change the potential hydrogenionic level (pH) for a range between 10 and 13. Preferably, the washing inputs comprise any type of alkaline chemical known by those skilled in the technical subject, it is conventionally used in clothes washing processes.

(E) Triggering the mechanical stirring means of washing machine so to generate friction between textiles.

(F) introducing again aqueous solution with hydrogenionic potential level (pH) in a range of 5 to 7 until it reaches the selected level of water column. Also preferably, the aqueous solution of this step comprises “pure” water of the supply network.

The sub-step (A) comprises, in general, a common and necessary step to any process of washing clothes, usually those being performed by a user.

Through the sub-steps (B) and (C), there is a decrease in the time of inhibitory action of perborate oxidizing agent to “detergent type A” enzymes, responsible for the removal of proteinaceous soil. Of course, this effect is optimized when the textiles are exposed to “detergent type A” enzymes without the particles of the oxidizing agent has been completely dissolved.

Through the sub-steps (D) and (E), other soil (standard soiling) are removed from the textiles. Steps D, E, F comprise the continuation of the wash cycle and serve for the removal of other debris, even if clothing be exclusively bloodstained still needed the three stages in question, because in them occur the feasibility of the mechanical action and circulation of washing solution between the fabric fibers.

1. Washing process including step of proteinaceous soils removal, capable of implement on washing machines, CHARACTERIZED by the fact that comprises, at least, the following sub-steps:
(A) Introduction of textile articles to be washed inside the washing basket;
(B) Filling the washing basket until reaches between 45% to 65% of the water column selected with aqueous solution with level of hydrogenionic potential (pH) between 5 and 7;
(C) Maintenance of textile articles submerged on the aqueous solution with hydrogenionic potential level (pH) between 5 and 7 during at least 90 seconds;
(D) Introducing the washing inputs on the aqueous solution to alter the hydrogenionic potential level (pH) for between 10 and 13;
(E) Adding the mechanical stirring means of the washing machine to generate friction between the textile articles and at least one portion of the washing basket; and
(F) Introduction, again, of an aqueous solution with hydrogenionic potential level (pH) between 5 and 7 until reaches 100% of water column level selected.

2. Washing process including step of proteinaceous soils removal, according to claim 1, CHARACTERIZED by the fact that the aqueous solution of step (B) comprises pure water.

3. Washing process including step of proteinaceous soils removal, according to claim 1, CHARACTERIZED by the fact that the washing inputs of step (D) comprises a formulation mainly composed by base powder blown with enzyme and foam inhibitor, tetra hydrate sodium perborate and bleach activator tetra acetyl ethylene diamine.
